(19) United States
(12) Patent Application Publication
(10) Pub. No.: US 2017/0362995 A1
(43) Pub. Date: Dec. 21, 2017

(54) VEHICLE AIR INTAKE SYSTEM

(71) Applicant: GM Global Technology Operations LLC, Detroit, MI (US)

(72) Inventors: William C. Saindon, Goodrich, MI (US); Sergio Quelhas, Ann Arbor, MI (US); Werner Filsinger, Wiesbaden (DE); Eric A. Weir, South Lyon, MI (US); John W. Myers, Howell, MI (US); Kai Becker, Oftersheim (DE)

(21) Appl. No.: 15/440,661

(22) Filed: Feb. 23, 2017

Related U.S. Application Data
(60) Provisional application No. 62/351,043, filed on Jun. 16, 2016.

(51) Int. Cl. F02B 29/04; B60K 13/02; F02D 9/10; F02M 35/10

(52) U.S. Cl. CPC F02B 29/0418; F02M 35/10157; B60K 13/02; F02B 29/0493; F02D 9/10

(57) ABSTRACT

A vehicle having an air intake system includes a charge air cooler, an intake duct, an outlet duct, and a bypass duct. The charge air cooler has a charge air inlet that is disposed at a first end of a charge air cooler core and a charge air outlet that is disposed at a second end of the charge air cooler core. The intake duct extends between an outlet of a turbocharger and the charge air inlet. The outlet duct extends between the charge air outlet and a throttle body having a throttle body valve that is operatively connected to an engine intake manifold. The bypass duct has a bypass valve. The bypass duct is connected to the charge air inlet and the charge air outlet. The bypass valve is configured to selectively facilitate bypass flow through the bypass duct.

### CROSS-REFERENCES TO RELATED APPLICATIONS

This patent application claims priority to U.S. Provisional Patent Application Ser. No. 62/351,043, filed Jun. 16, 2016 which is incorporated herein by reference in its entirety.

### INTRODUCTION

The present disclosure relates to a vehicle air intake system.

### BACKGROUND

A charge air cooler (CAC) is generally installed with an internal combustion (IC) engine to cool intake air that passes through a turbocharger and into an intake manifold. The charge air cooler passes the intake air through a heat exchanger that reduces the intake air temperature. Condensation may form within the intake air path of the heat exchanger or on the charge air cooler.

Accordingly, it is desirable to reduce or control condensation formation on the heat exchanger or on the charge air cooler.

### SUMMARY

In one illustrative embodiment of the present disclosure, a vehicle is provided. The vehicle includes a turbocharger, a charge air cooler, an internal combustion engine, a bypass duct, a bypass valve, and a controller. The turbocharger has an inlet and an outlet. The charge air cooler has a charge air inlet in fluid communication with the outlet of the turbocharger and a charge air outlet. The internal combustion engine is provided with a throttle body, having a throttle body valve, in fluid communication with the charge air outlet. The bypass duct is connected between the charge air inlet and the charge air outlet. The bypass valve is operatively connected to the bypass duct. The controller is in communication with the throttle body and the bypass valve. The controller is configured to, in response to a temperature being less than a threshold, operate the bypass valve to facilitate bypass flow through the bypass duct.

In addition to one or more of the features described herein, the charge air inlet is defined by a first header that is disposed at a first end of a charge air cooler core that is in fluid communication with the outlet of the turbocharger through an intake duct and a charge air outlet that is defined by a second header that is disposed at a second end of the charge air cooler core.

In addition to one or more of the features described herein, the bypass duct has a first bypass duct end that is directly connected to the first header and a second bypass duct end that is directly connected to the second header.

In addition to one or more of the features described herein, the charge air cooler core includes a plurality of passages that extend between the first header and the second header.

In addition to one or more of the features described herein, the controller is further configured to, in response to the temperature being greater than the threshold, operate the bypass valve to inhibit bypass flow through the bypass duct.

In addition to one or more of the features described herein, the temperature is an ambient air temperature.

In addition to one or more of the features described herein, the temperature is provided to the controller by a mass airflow sensor positioned proximate the inlet of the turbocharger.

In addition to one or more of the features described herein, the first header defines a first bypass port that is directly connected to the first bypass duct end and the second header defines a second bypass port that is directly connected to the second bypass duct end.

In addition to one or more of the features described herein, the engine includes an engine intake manifold in fluid communication with the throttle body.

In addition to one or more of the features described herein, a manifold absolute temperature sensor is positioned to measure a manifold temperature of the engine intake manifold.

In addition to one or more of the features described herein, the controller is further configured to, in response to the manifold temperature exceeding a manifold temperature threshold, operate the bypass valve to inhibit bypass flow through the bypass duct.

In another illustrative embodiment of the present disclosure, a vehicle is provided. The vehicle includes a charge air cooler, a bypass duct, a bypass valve, and a controller. The charge air cooler has a charge air inlet in fluid communication with an outlet of a turbocharger through an intake duct. The charge air cooler has a charge air outlet in fluid communication with a throttle body having a throttle body valve that is operatively connected to an engine intake manifold through an outlet duct. The bypass duct has a first bypass duct end that is directly connected to the intake duct and a second bypass duct end that is directly connected to the outlet duct. The bypass valve is operatively connected to the bypass duct. The controller is in communication with the throttle body and the bypass valve. The controller is configured to operate the bypass valve to permit bypass flow through the bypass duct, in response to an environmental parameter.

In addition to one or more of the features described herein, the environmental parameter is provided by a mass airflow sensor that is positioned proximate an inlet of the turbocharger and in communication with the controller.

In addition to one or more of the features described herein, the environmental parameter is at least one of an ambient air temperature and an ambient air humidity.

In yet another illustrative embodiment of the present disclosure, an air intake system is provided. The air intake system includes a charge air cooler, an intake duct, an outlet duct, and a bypass duct. The charge air cooler has a charge air inlet that is disposed at a first end of a charge air cooler core and a charge air outlet that is disposed at a second end of the charge air cooler core. The intake duct extends between an outlet of a turbocharger and the charge air inlet. The outlet duct extends between the charge air outlet and a throttle body having a throttle body valve that is operatively connected to an engine intake manifold. The bypass duct has a bypass valve. The bypass duct is connected to the charge air inlet and the charge air outlet. The bypass valve is configured to selectively facilitate bypass flow through the bypass duct.

In addition to one or more of the features described herein, the bypass duct includes a first bypass duct end that is directly connected to the intake duct and a second bypass duct end that is directly connected to the outlet duct.

In addition to one or more of the features described herein, the charge air inlet is defined by a first header that is disposed at a first end of a charge air cooler core and the charge air outlet is defined by a second header that is disposed at a second end of the charge air cooler core.

In addition to one or more of the features described herein, the first header defines a first bypass port that is directly connected to the bypass duct and the second header defines a second bypass port that is directly connected to the bypass duct.

In addition to one or more of the features described herein, the bypass valve and the throttle body valve are in communication with a controller that is configured to operate the bypass valve to facilitate bypass flow through the bypass duct, in response to an ambient temperature being less than a threshold.

In addition to one or more of the features described herein, the controller is further configured to operate the bypass valve to inhibit bypass flow through the bypass duct, in response to a manifold temperature of the engine intake manifold being greater than a manifold temperature threshold.

The above features and advantages and other features and advantages of the present disclosure are readily apparent from the following detailed description of the present disclosure when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a representative illustration of a vehicle including an internal combustion engine having an air intake system;

FIG. 2 is a schematic illustration of an air intake system according to a first embodiment of the present disclosure; and

FIG. 3 is a schematic illustration of an air intake system according to a second embodiment of the present disclosure.

### DESCRIPTION OF THE EMBODIMENTS

The following description is merely illustrative in nature and is not intended to limit the present disclosure, its application or uses. It should be understood that throughout the drawings, corresponding reference numerals indicate like or corresponding parts and features.

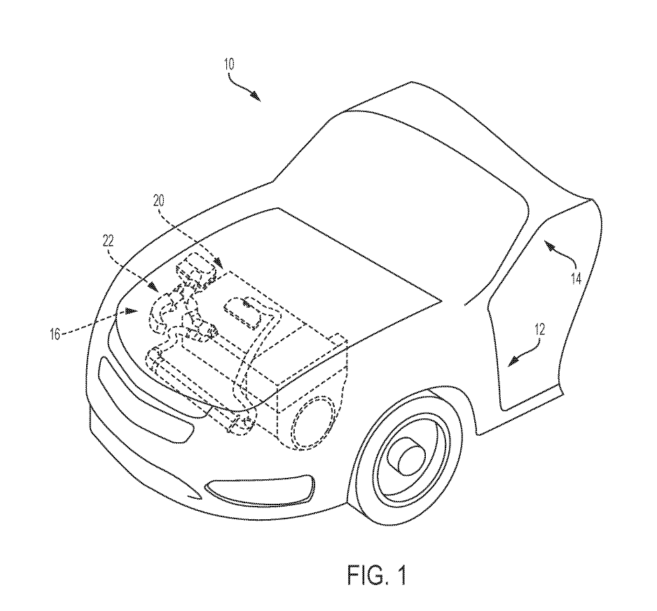

Referring to FIG. 1 a vehicle 10 is shown. The vehicle 10 includes a vehicle structure or body 12 that defines a passenger compartment 14 and an engine compartment 16. The passenger compartment 14 may be separated from the engine compartment 16 by a barrier such as a structural wall or the like.

The vehicle 10 is provided with an engine system 20 (i.e. an internal combustion engine) and an air intake system 22 that is operatively connected to the engine system 20. The engine system 20 and the air intake system 22 are disposed within the engine compartment 16.

Referring to FIGS. 1-3, the engine system 20 includes an air inlet 30, a turbocharger 32, an engine intake manifold 34, and an engine crank case 36.

The air inlet 30 is configured to receive ambient intake air that is directed through an air inlet duct 40 through an air inlet housing 42 having a filter element 44 and ultimately through an air outlet duct 46. A mass airflow sensor 50 is positioned relative to the air outlet duct 46 to measure mass airflow of the ambient intake air. The mass airflow sensor 50 is configured to monitor or measure environmental parameters such as ambient air temperature, ambient air humidity, or the like.

The turbocharger 32 is positioned downstream of the air inlet 30. In at least one embodiment, the turbocharger 32 may be a supercharger. The turbocharger 32 includes an inlet 60 and an outlet 62. The inlet 60 is fluidly connected and/or directly connected to the air outlet duct 46. The turbocharger 32 is configured to compress intake air and provide the compressed intake air to the engine intake manifold 34.

The engine intake manifold 34 may be provided with an engine throttle body 70 having a throttle body valve 72, a manifold absolute pressure sensor 74, and a manifold absolute temperature sensor 76. The engine throttle body 70 is operatively connected to the engine intake manifold 34 and is configured to regulate an amount/volume of air flowing into the engine intake manifold 34. The throttle body valve 72 is disposed within the engine throttle body 70. The throttle body valve 72 is movable between a plurality of positions in response to a control signal provided by an electronic controller or an engine control unit or in response to a direct mechanical linkage to an accelerator pedal. The movement of the throttle body valve 72 between the plurality of positions adjusts or regulates an amount of intake air that is provided to the engine intake manifold 34 and ultimately to a combustion chamber of the internal combustion engine. The position of the throttle body valve 72 may be varied based on the position of the accelerator pedal. In at least one embodiment, a throttle position sensor may be provided that is positioned to measure a position of the throttle body valve 72.

The manifold absolute pressure sensor 74 is positioned on or within the engine intake manifold 34 and is positioned to measure an absolute pressure of air or gases within the engine intake manifold 34. The manifold absolute temperature sensor 76 is positioned on or within the engine intake manifold 34 and is positioned to measure an absolute temperature of air or gases within the engine intake manifold 34.

The engine crank case 36 is operatively connected to the engine intake manifold 34. A first conduit 80 is in fluid communication with the engine intake manifold 34 and the engine crank case 36. The first conduit 80 extends between the engine intake manifold 34 and engine crank case 36 and is configured to admit or to permit the venting of gases or fluid from the engine crank case 36 into the engine intake manifold 34 when the engine manifold absolute pressure is less than an engine crank case pressure. A second conduit 82 is in fluid communication with the engine crank case 36 and the air outlet duct 46. The second conduit 82 extends between the engine crank case 36 and the air outlet duct 46. The second conduit 82 is configured to admit or permit the venting of gases or fluid from the engine crank case 36 into the air outlet duct 46 and ultimately into the turbocharger 32 when the manifold absolute pressure is greater than the engine crank case pressure.

The air intake system 22 is disposed between the outlet 62 of the turbocharger 32 and the engine throttle body 70 operatively connected to the engine intake manifold 34. The air intake system 22 is configured to condition the air that exits the outlet 62 of the turbocharger 32 prior to the air entering the engine intake manifold 34.

The air intake system 22 includes a charge air cooler 90 and a bypass system 92.

The charge air cooler 90 is arranged to cool the compressed intake air that exits the outlet 62 of the turbocharger 32. The charge air cooler 90 includes a charge air cooler core 100 that is disposed between a first header 102 and a second header 104. The first header 102 is commonly referred to as a hot side of the charge air cooler 90 and the second header 104 is commonly referred to as a cold side of the charge air cooler 90.

The charge air cooler core 100 includes a plurality of passages 110 that extend from a first end 112 of the charge air cooler core 100 to a second end 114 of the charge air cooler core 100. The first end 112 of the charge air cooler core 100 is disposed proximate and is operatively connected to the first header 102. The second end 114 of the charge air cooler core 100 is disposed proximate and is operatively connected to the second header 104.

The plurality of passages 110 fluidly connect the first header 102 and the second header 104. The plurality of passages 110 may be configured as a plurality of tubes having a plurality of fins, bars, or the like disposed between adjacent tubes to enhance heat transfer from the tubes.

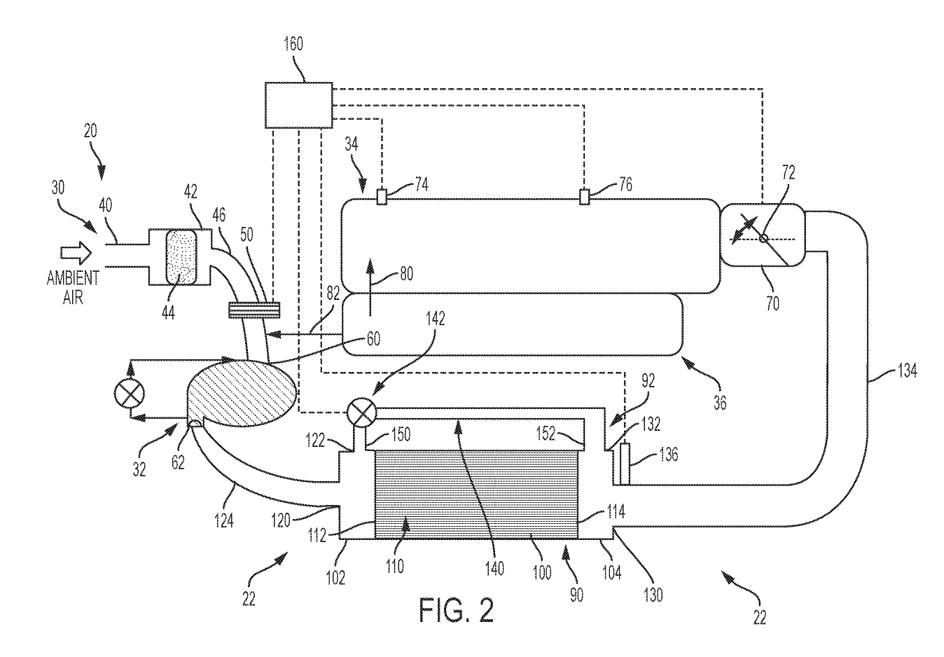

Referring to FIG. 2, the first header 102 includes a charge air inlet 120 and a first bypass port 122. The charge air inlet 120 and the first bypass port 122 may be defined by or may be integrally formed with the first header 102. The charge air inlet 120 is in fluid communication with and is directly connected to the outlet 62 of the turbocharger 32 via an intake duct 124. The intake duct 124 directs the compressed intake air from the turbocharger 32 to the charge air inlet 120.

The first bypass port 122 is spaced apart from the charge air inlet 120. In at least one embodiment, the first bypass port 122 is disposed substantially transverse to the charge air inlet 120.

The second header 104 includes a charge air outlet 130 and a second bypass port 132. The charge air outlet 130 and the second bypass port 132 may be defined by or may be integrally formed with the second header 104. The charge air outlet 130 is in fluid communication with and is directly connected to the engine throttle body 70 that is operatively connected to the engine intake manifold 34 by an outlet duct 134. The outlet duct 134 directs intake air that is cooled by the charge air cooler core 100 to the engine intake manifold 34.

The second bypass port 132 is spaced apart from the charge air outlet 130. In at least one embodiment, the second bypass port 132 is disposed substantially transverse to the charge air outlet 130.

In at least one embodiment, a throttle inlet absolute pressure sensor 136 is positioned proximate the charge air outlet 130. The throttle inlet absolute pressure sensor 136 is positioned to measure a pressure of the intake air that may be discharged from or through the charge air outlet 130.

Operation of the vehicle 10 in cold climates (below 0° C.) may enable moisture present in the intake air to condense and subsequently freeze within the charge air inlet 120 and/or the heat exchanger of the charge air cooler core 100 during low flow, steady state internal combustion engine operation. When the intake manifold pressure is greater than the engine crankcase pressure (i.e. flow through the second conduit 82 is enabled) the flow of the engine crankcase ventilation air with bypass gases may cause ice or condensation to collect inside the charge air cooler 90 and cause a blockage within the charge air cooler 90 that inhibits airflow through the charge air cooler 90. The condensation and the ice that may collect inside the charge air cooler 90 may be ingested by the internal combustion engine through the engine intake manifold 34 after a sudden acceleration event.

A sudden acceleration event may be a change in the throttle body valve 72 position of the engine throttle body 70 greater than a threshold position. The change in throttle body valve position may be within the range of 25% to greater than 50%. In at least one embodiment, a sudden acceleration event may be a change in internal combustion engine power output within the range of 25% to 50%. In further embodiments, a sudden acceleration event may be a change in accelerator pedal position greater than a threshold accelerator pedal position.

Condensation may also collect inside the charge air cooler 90 or ice may form on or inside at least one of the charge air cooler core 100, the first header 102, and the second header 104 of the charge air cooler 90 during operation of the vehicle 10 and a combination of at least two of the following: i) low ambient air temperature (ambient air temperatures less than 0° C.), ii) a manifold absolute pressure above an ambient atmospheric pressure, or iii) fluid or moisture flows into the turbocharger 32 or into the charge air cooler 90.

The bypass system 92 is provided to reduce or inhibit the collection of condensation inside the charge air cooler 90 and/or reduce or inhibit ice formation on or inside at least one of the throttle inlet absolute pressure sensor 136, the charge air cooler core 100, the first header 102, and the second header 104. The bypass system 92 may facilitate or enable the compressed intake air to completely bypass the charge air cooler 90 to inhibit the condensation of moisture within the compressed intake air. The bypassed intake air may heat the first header 102 and/or the second header 104 to expose an iced area of the charge air cooler 90 to warmer air and melt or remove the ice formation. The compressed intake air that flows through the bypass system 92 is referred to as bypass flow.

The bypass system 92 includes a bypass duct 140 and a bypass valve 142. Referring to FIG. 2, the bypass duct 140 is fluidly connected, or directly connected, to the first header 102 and the second header 104 of the charge air cooler 90. The bypass duct 140 has a first bypass duct end 150 that is fluidly connected or directly connected to the first bypass port 122 and a second bypass duct end 152 that is fluidly connected or directly connected to the second bypass port 132.

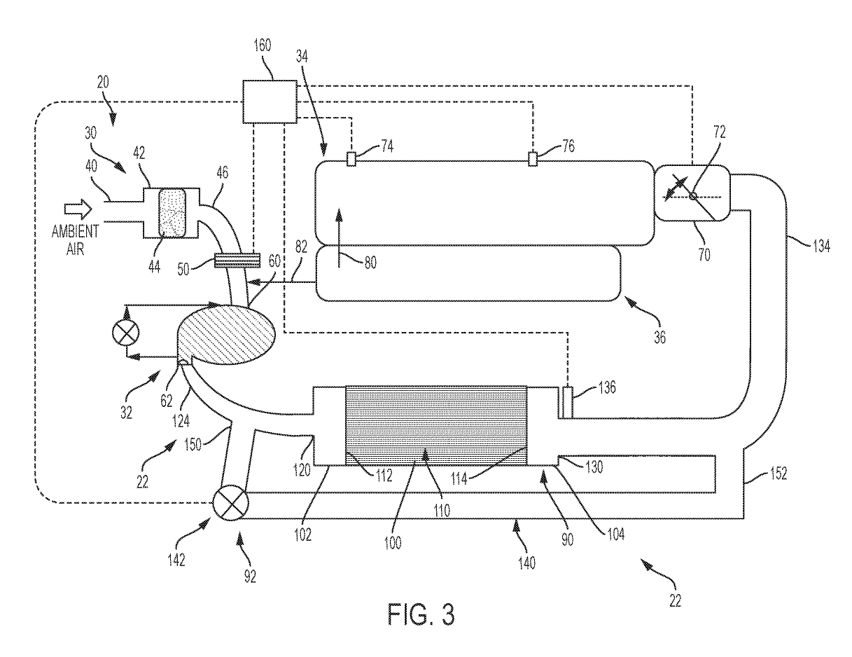

Referring to FIG. 3, in another embodiment, the bypass duct 140 is fluidly connected or directly connected to the intake duct 124 and the outlet duct 134. The first bypass duct end 150 is directly connected to the intake duct 124 by a connector, a fitting, or the like and the second bypass duct end 152 is similarly directly connected to the outlet duct 134 by a connector, a fitting, or the like.

Referring to FIGS. 2 and 3, the bypass valve 142 is operatively connected to the bypass duct 140. The bypass valve 142 is disposed between the first bypass duct end 150 and the second bypass duct end 152. In at least one embodiment, the bypass valve 142 is positioned within the bypass duct 140. The bypass valve 142 is movable between a first position that inhibits bypass flow through the bypass duct 140 and a second position that facilitates or permits bypass flow through the bypass duct 140. The bypass valve may be a solenoid.

The mass airflow sensor 50, the engine throttle body 70, the manifold absolute pressure sensor 74, the manifold absolute temperature sensor 76, the throttle inlet absolute pressure sensor 136 and the bypass valve 142 may all be in communication with a controller 160. The controller 160 is provided within input communication channels configured to receive signals indicative of an accelerator pedal position, an ambient air temperature, an ambient air humidity, an intake air mass flow rate, a throttle body valve position, a manifold absolute pressure, a manifold absolute temperature, and a throttle inlet absolute pressure. The controller 160 is provided with output communication channels configured to provide signals to the bypass valve 142 to control a position of the bypass valve 142.

The controller 160 is provided with control logic or is programmed or configured to operate the bypass valve 142 to selectively facilitate bypass flow through the bypass duct 140 during conditions in which condensation and/or ice may form, as in cold weather having ambient temperatures less than 0° C. The controller 160 is configured to operate the bypass valve 142 to move from a closed position towards an open position to facilitate bypass flow through the bypass duct 140 in response to a sudden acceleration event or an ambient air temperature less than 0° C.

The controller 160 is further configured to operate the bypass valve 142 to move from the open position towards the closed position to inhibit bypass flow through the bypass duct 140 in response to a continuous high acceleration application in which a manifold temperature of the engine intake manifold 34, measured by the manifold absolute temperature sensor 76, exceeds a manifold temperature threshold or a cessation of the sudden acceleration event. The cessation of the sudden acceleration event may be based on the throttle body valve position becoming less than the threshold position, the internal combustion engine operating condition changing from a transient to a steady-state condition, or the accelerator pedal position becoming substantially constant.

In at least one embodiment, the controller 160 is configured to operate the bypass valve 142 to move from the open position towards the closed position to inhibit bypass flow through the bypass duct 140 in response to a temperature of the second header 104 becoming greater than a threshold header temperature.

The controller 160 may be provided as part of an engine control module, engine control unit, or may be provided as part of an overall vehicle monitoring system. The controller 160 may include a microprocessor or central processing unit (CPU) in communication with various types of computer readable storage devices or media that may include volatile and nonvolatile storage in read-only memory (ROM), random-access memory (RAM), and keep-alive memory (KAM), for example.

KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 160 and controlling the engine system 20 or the air intake system 22.

Throughout this specification, the term “attach,” “attachment,” “connected”, “coupled,” “coupling,” “mount,” or “mounting” shall be interpreted to mean that a component or element is in some manner connected to or contacts another element, either directly or indirectly through at least one intervening element, or is integrally formed with the other element.

While the present disclosure has been described with reference to illustrative embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Furthermore, various elements of the illustrative embodiments may be combined to produce further illustrative embodiments without departing from the scope of the present disclosure. Therefore, it is intended that the present disclosure not be limited to the particular embodiments disclosed, but that the present disclosure will include all embodiments falling within the scope of the application.

What is claimed is:

1. A vehicle, comprising:
a turbocharger having an inlet and an outlet;
a charge air cooler having a charge air inlet in fluid communication with the outlet of the turbocharger and a charge air outlet;
an internal combustion engine provided with a throttle body, having a throttle body valve, in fluid communication with the charge air outlet;
a bypass duct connected between the charge air inlet and the charge air outlet;
a bypass valve operatively connected to the bypass duct; and
a controller in communication with the throttle body and the bypass valve, the controller being configured to, in response to a temperature being less than a threshold, operate the bypass valve to facilitate bypass flow through the bypass duct.

2. The vehicle of claim 1, wherein the charge air inlet is defined by a first header disposed at a first end of a charge air cooler core in fluid communication with the outlet of the turbocharger through an intake duct and a charge air outlet defined by a second header disposed at a second end of the charge air cooler core.

3. The vehicle of claim 2, wherein the bypass duct has a first bypass duct end directly connected to the first header and a second bypass duct end directly connected to the second header.

4. The vehicle of claim 2, wherein the charge air cooler core includes a plurality of passages extending between the first header and the second header.

5. The vehicle of claim 3, wherein the controller is further configured to, in response to the temperature being greater than the threshold, operate the bypass valve to inhibit bypass flow through the bypass duct.

6. The vehicle of claim 5, wherein the temperature is an ambient air temperature.

7. The vehicle of claim 6, wherein the temperature is provided to the controller by a mass airflow sensor positioned proximate the inlet of the turbocharger.

8. The vehicle of claim 3, wherein the first header defines a first bypass port that is directly connected to the first bypass duct end and the second header defines a second bypass port that is directly connected to the second bypass duct end.

9. The vehicle of claim 8, wherein the engine includes an engine intake manifold in fluid communication with the throttle body.

10. The vehicle of claim 9, further comprising a manifold absolute temperature sensor positioned to measure a manifold temperature of the engine intake manifold.

11. The vehicle of claim 10, wherein the controller is further configured to, in response to the manifold temperature exceeding a manifold temperature threshold, operate the bypass valve to inhibit bypass flow through the bypass duct.

12. A vehicle, comprising:
a charge air cooler having a charge air inlet in fluid communication with an outlet of a turbocharger through an intake duct and a charge air outlet in fluid communication with a throttle body having a throttle body valve that is operatively connected to an engine intake manifold through an outlet duct;
a bypass duct having a first bypass duct end directly connected to the intake duct and a second bypass duct end directly connected to the outlet duct;
a bypass valve operatively connected to the bypass duct; and
a controller in communication with the throttle body and the bypass valve, the controller being configured to in response to an environmental parameter, operate the bypass valve to permit bypass flow through the bypass duct.

13. The vehicle of claim 12, wherein the environmental parameter is provided by a mass airflow sensor positioned proximate an inlet of the turbocharger and in communication with the controller.

14. The vehicle of claim 13, wherein the environmental parameter is at least one of an ambient air temperature and an ambient air humidity.

15. An air intake system, comprising:
a charge air cooler having a charge air inlet disposed at a first end of a charge air cooler core and a charge air outlet disposed at a second end of the charge air cooler core;
an intake duct extending between an outlet of a turbocharger and the charge air inlet;
an outlet duct extending between the charge air outlet and a throttle body having a throttle body valve operatively connected to an engine intake manifold; and
a bypass duct having a bypass valve, the bypass duct being connected to the charge air inlet and the charge air outlet, the bypass valve being configured to selectively facilitate bypass flow through the bypass duct.

16. The air intake system of claim 15, wherein the bypass duct includes a first bypass duct end that is directly connected to the intake duct and a second bypass duct end that is directly connected to the outlet duct.

17. The air intake system of claim 15, wherein the charge air inlet is defined by a first header disposed at a first end of a charge air cooler core and the charge air outlet is defined by a second header disposed at a second end of the charge air cooler core.

18. The air intake system of claim 17, wherein the first header defines a first bypass port directly connected to the bypass duct and the second header defines a second bypass port directly connected to the bypass duct.

19. The air intake system of claim 15, wherein the bypass valve and the throttle body valve are in communication with a controller that is configured to operate the bypass valve to facilitate bypass flow through the bypass duct, in response to an ambient temperature being less than a threshold.

20. The air intake system of claim 19, wherein the controller is further configured to operate the bypass valve to inhibit bypass flow through the bypass duct, in response to a manifold temperature of the engine intake manifold being greater than a manifold temperature threshold.
